(19) United States
(12) Patent Application Publication
(10) Pub. No.: US 2002/0074366 A1
(43) Pub. Date: Jun. 20, 2002

(54) Vented fluid container closure

(76) Inventor: John L Young, Whittier, CA (US)

Correspondence Address: Ronald L. Wanke, Jenner & Block, One IBM Plaza, Chicago, IL, 60611, US

(21) Appl. No.: 09/994,303

(22) Filed: Nov. 26, 2001

Related U.S. Application Data
(63) Continuation-in-part of application No. 09/736,350, filed on Dec. 14, 2000.

(51) Int. Cl. B67D 5/06

(52) U.S. Cl. 222/484; 222/525

(57) ABSTRACT

A vented closure for a fluid container which will not freely pour includes a cap movable between open and closed positions relative to an annular base collar. The movable cap can be slidable to form a push-pull type closure, or can be rotatable to form a flip-type closure. In an open position, a primary liquid passageway extends through the closure to a dispensing opening. One or more air vents of small size are located in the base collar at positions spaced from the dispensing opening. A divider is located to create a secondary liquid passageway to convey liquid directly into contact with the air vents which can self-seal by surface tension of the liquid. The vent aperture can be protected by overlapping portions of the movable cap.

### CROSS-REFERENCE TO RELATED APPLICATION

This application is a continuation-in-part of my application Ser. No. 09/736,350, filed Dec. 13, 2000 and entitled “Vented Fluid Container Closure”.

### FIELD OF THE INVENTION

The present invention relates generally to closures for fluid containers and, more particularly, to a closure for a fluid container that is vented and has a non-pouring type fluid passage.

### BACKGROUND OF THE INVENTION

Water and other non-carbonated beverages, and particularly sports drinks, are sold in individual servings in the form of plastic bottles which are squeezable. Such bottles typically have caps in the form of a pull open/push closed type closure, which typically provides a single fluid passage and thus is not vented. The lack of a vent in the closure causes the container to collapse as a consumer draws a beverage from the container while drinking, due to a pressure differential that is created between the fluid and the exterior of the container, the external pressure being higher as the exiting liquid causes internal pressure to decrease. At some point during the drinking process, depending on the size of the container, no additional liquid can be withdrawn from the container until the pressure is equalized by stopping the drinking process and allowing air to rush in through the single fluid passage in the closure. This equalization can cause a reflux or backwash from the consumer's mouth into the container, which tends to contaminate the fluid in the container. Because of these problems, consumers frequently equalize pressure by holding the bottle away from the mouth and squeezing the bottle in a series of squirts, with pressure equalization taking place between each squirt. This procedure often results in spills of the fluid, and results in the consumer drinking less than he might if it were easier to dispense fluid. The lack of a vent in these closures also limits the freedom of design and materials for the container due to the fact that the container must be able to collapse.

Conventional fluid containers are sometimes vented, but the vent typically is part of the container itself, and not part of the closure. Vented closures intended for pouring are known, but are undesirable for use in non-pouring type closures in which fluid will not continuously pour out of the bottle when the bottle is tilted downwardly. Sports bottles are an example of a non-pouring type closure which are intended to be left open for quick drinks during an activity, and can be easily knocked over. Furthermore, most pouring-type closures require the user to hold the container with particular orientation, often with the spout oriented downwardly for pouring, and such pouring closures are not suitable for sports bottles or the like in which the user may raise the closure without regard to any particular orientation to the closure. In general, pouring type closures are not suitable for sports bottles and other containers in which the liquid exits in spurts due to squeezing of the container and/or placing the user's mouth around the closure opening to draw liquid out of the container.

Other closure systems utilize a flap valve or diaphragm to regulate the equalization pressure and/or prevent liquid from leaking through vent passages for the closure. The additional components and assembly processes required to incorporate a flap valve or diaphragms or washers in a closure adds prohibitive expense and complexity to the closure. A container is known that is designed for the specialized application of drinking while riding a bicycle, but is designed to allow the user to drink without tilting the head back. This device has a vent, but requires a flap valve and uses a straw to draw fluid from the bottom of the container. Such approaches are not adaptable to a standard beverage container and add prohibitive expense and complexity to the closure.

The manufacturing cost of closures used on sports drink containers and the like is critical. An increase of fractions of a cent can severely impact marketability by the closure manufacturer since consumers usually are focused on the sports beverage or supplier and are generally unwilling to pay more for the bottle and closure which contains the beverage. Likewise, it is very important that any closure should be compatible with existing bottling and assembly equipment and should be usable in connection with standard bottling and assembly processes. The types of closures proposed in the past have been incompatible with these requirements.

One objective of the present invention is to provide an improved vented fluid container closure of the non-pouring type that is adaptable to a standard beverage container.

It is another objective of the present invention to provide a vented fluid container closure that is readily manufactured using molding and other equipment currently used for beverage container closures and which is easily adaptable to current beverage filling and processing equipment.

It is a further objective of the present invention to solve the problem of contamination of fluid while drinking due to reflux in a squeezable plastic container which dispenses liquid in squirts when held overhead in no particular orientation.

It is yet another objective of the present invention to provide a vented closure that allows drawing of fluid out of the container without the container collapsing or reflux occurring.

It is still another objective of the present invention to provide a liquid closure that is vented to air and has simple vent passageways that self-seal using the surface tension of the liquid itself.

### SUMMARY OF THE INVENTION

In order to achieve the foregoing objectives, the vented closure of the present invention provides a non-pouring type closure with a fluid passage and one or more vent passages of predetermined dimensions and placement in an annular collar adaptable to a standard beverage container. The fluid passage and the one or more vent passages may be opened and closed by the same cap. When the cap is open and inverted to a drinking position, surface tension of the liquid will seal the one or more vent passages which are in direct contact with the liquid, and eliminate special sealing structure previously necessary for the vent passageways. The vent openings are sufficiently small size and placement relative to the main fluid exit so that the weight of the liquid which is in direct contact with the vent openings does not exert sufficient force to overcome surface tension, and substantially prevents equalizing air from entering the vent passageways. The resulting pressure differential prevents liquid from exiting the bottle even when the closure is open and inverted.

When liquid is drawn out the main liquid passageway, as in the act of drinking due to squeezing the container and/or sucking on the open cap, sufficient additional force is applied to overcome the surface tension sealing the vent apertures, and equalizing air is drawn into the vent passage for as long as the drawing force is present. When the drawing force is removed, the surface tension of the liquid substantially reseals the vent and allows only a few drops of liquid to exit before differential pressure stops the flow.

The air entering the vent passageway is desirably separated from the flow of exiting liquid by a divider to prevent the air from becoming entrained. Several embodiments for the dividers are disclosed which are sufficiently open in configuration to allow the self-sealing action of the vent passageways and also the free entry of air while minimizing interaction between the air entering the container and liquid exiting the container.

One embodiment consists of a push-pull type cap that engages an annular collar. The cap is movable along the collar between open and closed positions, and when in the open position, the vent passage and fluid passage are both open. The divider which isolates the equalizing venting air from the exiting fluid can take several forms which generally are partially open in profile such that the open portion is opposite the main fluid passageway.

Other embodiments consist of a flip-type cap of generally U-shape which rotates about a center portion. An air vent is formed on one side of a raised portion. A divider which isolates the equalizing venting air from the main fluid flow can take several forms. The flip-type cap itself can have several configurations including a resilient sealing portion for improved sealing of the main liquid passageway.

### BRIEF DESCRIPTION OF THE DRAWINGS

The operational features of the present invention are explained in more detail with reference to the following drawings, in which like reference numerals refer to like elements, and in which:

FIG. 1 is an exploded top perspective view of a first embodiment of the vented closure attachable to a beverage container;

FIG. 2 is an exploded bottom perspective view of the first embodiment of the vented closure attachable to a beverage container;

FIG. 3 is a bottom view of the first embodiment of the vented closure of FIGS. 1 and 2;

FIG. 4 is a side cutaway view of the first embodiment of the vented closure in closed position;

FIG. 5 is a side cutaway view of the first embodiment of the vented closure in an open position without drawing forces and illustrates the self-sealing characteristics of the closure;

FIG. 6 is a side cutaway view of the first embodiment of the vented closure in an open position with drawing forces present to cause liquid flow and air venting of the closure;

FIGS. 7a to 7d are bottom perspective views of the first embodiment of the vented closure showing alternate dividers usable with the closure;;

FIG. 8a shows test apparatus for determining the sizing and location of the vent apertures, and FIG. 8b is a chart showing the test results;

FIG. 9 is a top perspective view of a second embodiment of the vented closure in an open position and attached to a beverage container;

FIG. 10 is a top perspective view of the second embodiment of the vented closure in a closed position and attached to a beverage container;

FIG. 11 is a side cutaway view of the second embodiment of the vented closure in the closed position and attached to a beverage container;

FIG. 12 is an exploded bottom and partially cutaway perspective view of the second embodiment of the vented closure;

FIG. 13 is a side cutaway view of the embodiment of FIG. 12 in the closed position; and

FIG. 14 is an enlarged cutaway view of the embodiment of FIG. 12 in an assembled and open position.

### DETAILED DESCRIPTION OF THE PREFERRED EMBODIMENTS

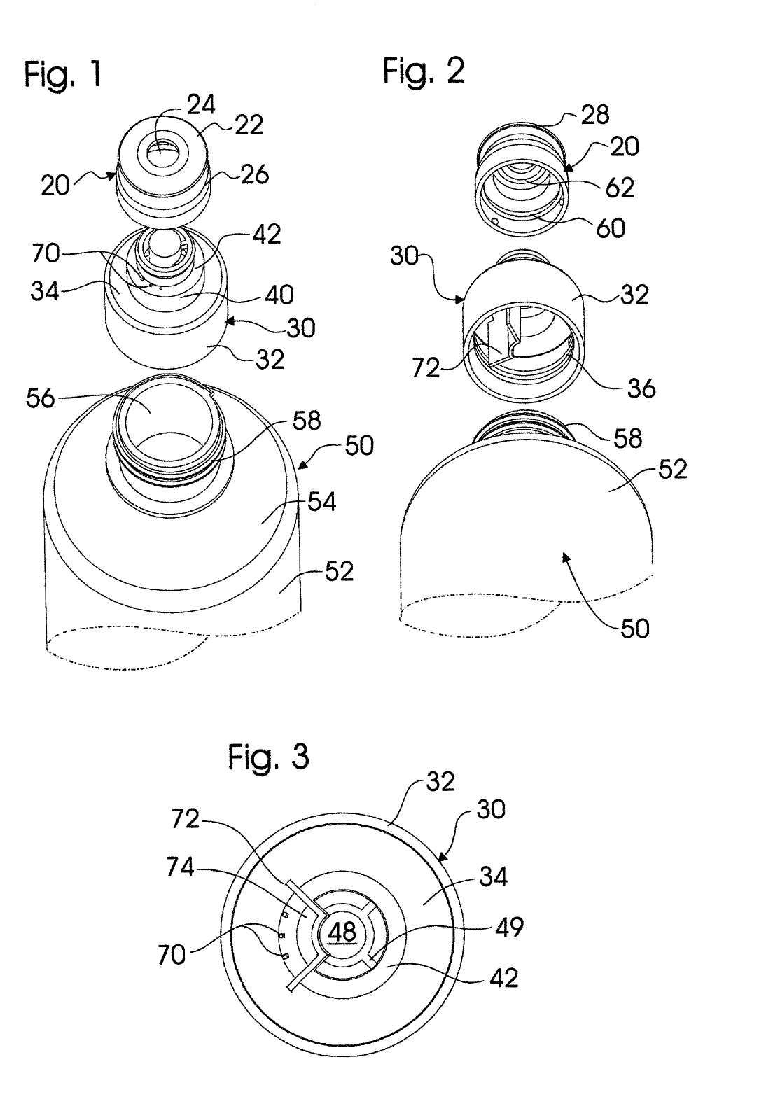

Turning first to FIGS. 1 to 6, a first embodiment of the vented fluid container closure of the present invention can be seen. The closure consists of two molded parts which move relative to each other. One molded part consists of a cap 20 which includes a top surface 22 containing a central circular bore 24 for the passage of fluid. An annular skirt 26 extends downwardly from the top 22 to define an open interior space. A rim or lip 28 extends around the periphery of the top surface 22 to provide a convenient surface for a user to grasp the cap for pull movement upwardly to move the cap to an open position or for a push movement downwardly to a closed position.

The second molded part which forms the closure consists of a base annular collar 30 which can be secured to a beverage container. In one preferred embodiment, the collar 30 consists of a series of increasingly smaller diameter and connected annular rings.

A first bottom annular ring of the greatest diameter is formed by a first side wall 32 extending in a longitudinal direction and terminating in a top annular shelf 34 with an upright annular rim 35. The shelf 34 extends radially inward from the annular rim 35. Side wall 32 has an interior surface which includes interior threads 36 for mating engagement with a beverage container.

A second annular ring of intermediate size consists of a second side wall 40 which mates with the shelf 34 and extends longitudinally upward to a top annular shelf 42 which is slightly tapered. The annular shelf 42 extends generally transversely inward and slightly upward to mate with a third or top annular ring having the smallest diameter.

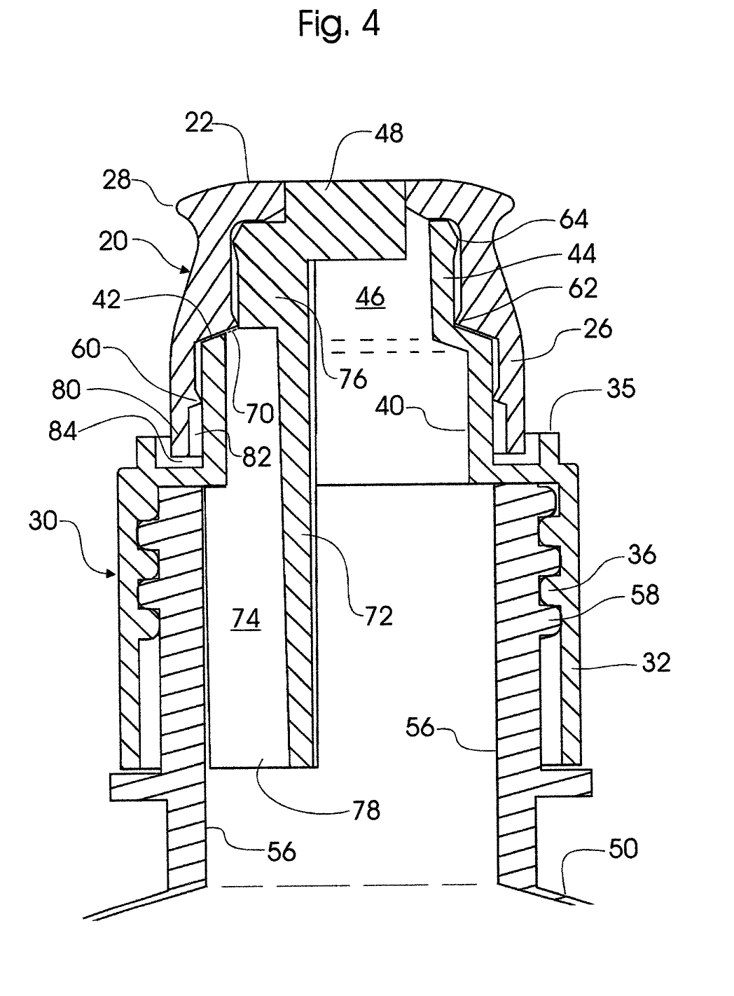

A top annular ring includes a third side wall 44 seen best in FIG. 4 which generally surrounds an interior fluid passageway 46. The third ring includes a circular stopper plug 48 connected via struts 49, see FIG. 3, to the third ring side wall 44. The stopper plug 48 is located in the center of the third annular ring which generally surrounds the circular plug 48. The center plug 48 is located so as to slidably engage and mate with the circular bore 24 when the cap 20 is moved to the closed position seen in FIG. 4. In this closed position, the stopper plug 48 blocks the fluid passageway 46 and prevents liquid in the container from exiting the closure. As will appear, the cap 20 surrounds and moves upwardly and downwardly relative to the second and third rings including the side walls 40 and 44.

The base collar 30 including the captured cap 20 is adapted to mate with a standard fluid container 50 which may be any container for containing a fluid, such as a bottle for a single serving of a liquid sport drink or water. The beverage container 50 typically has plastic side walls 52 which are squeezable or deformable in order to dispense liquid from the container. The container terminates in a top wall 54 having an upright annular neck 56 which includes external threads 58 for mating engagement with the internal threads 36 of the base collar 30.

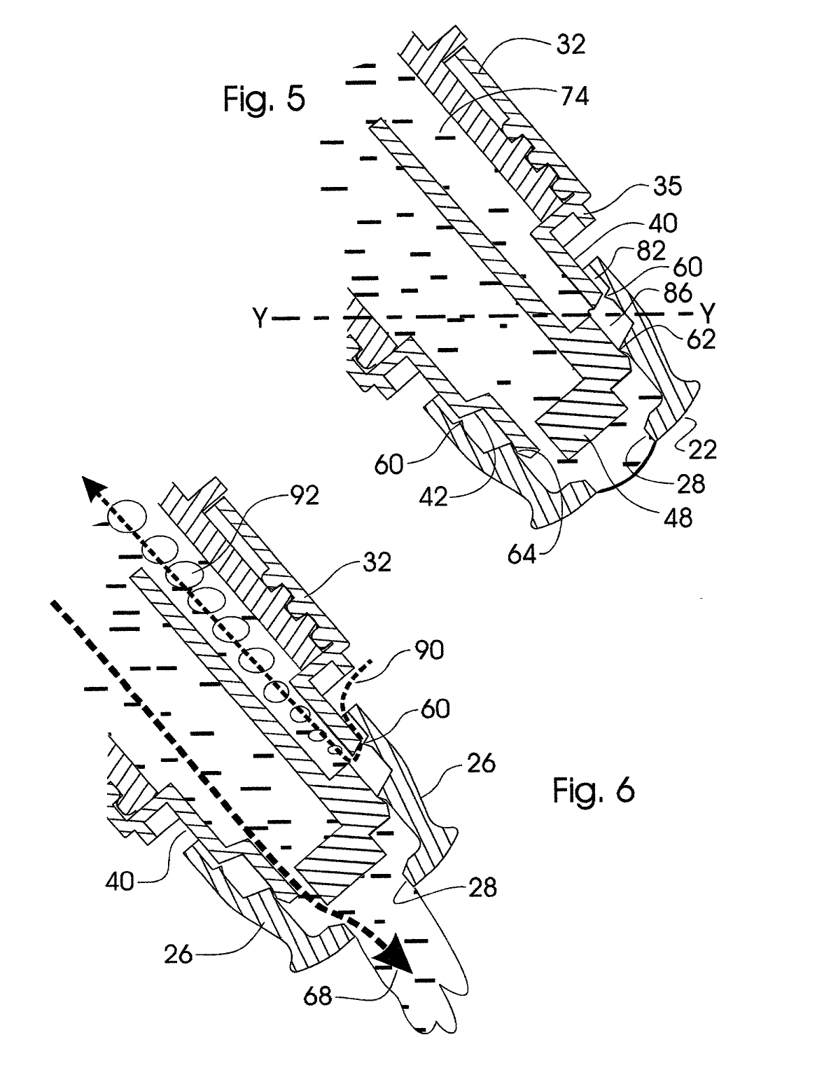

The cap 20 can move in a tight, frictionally-sealing and sliding motion along the second and third rings of the base collar 30. As seen in FIGS. 2 and 4, the cap 20 includes a lower annular ridge 60 and an upper annular ridge 62 which encircle the interior skirt wall 26 of the cap. The cap 20 can be slidably pushed downwardly to a fully retracted or closed position with respect to the base collar 30, as seen in FIG. 4. The cap circular bore is then sealed by the stopper plug 48 and blocks the fluid flow passage 46 which leads into the open interior of the upright container neck 56. To open, a user pulls longitudinally upward to slidably move the cap 20 along the second and third rings of the collar 30 to an open position as seen in FIGS. 5 and 6. The side wall 44 of the third ring includes a flaring rim or stop 64 which engages the cap upper annular ridge 62 to stop further outward movement and thus capture the slidable cap 20 to the base collar 30. The upward pull moves the cap circular bore 24 out of engagement with the stopper plug 48, and thus opens the fluid passageway 46 so that the liquid in the container can be disbursed along a fluid passageway shown by the arrow 68 in FIG. 6. To disburse liquid, the container side wall 52 is squeezed, and/or the user can place his or her mouth over the cap 20 while the container is tilted overhead as seen in FIG. 6 and suck on the cap 20 to create a vacuum so that there is a pressure differential to cause liquid from the container to exit along the arrow path 68.

Preferably the cap 20 and base collar 30 are each molded as a single piece of plastic. For example, cap 20 can be injection molded of low density polyethylene (LDPE) or PPL, but any suitable material may be used. The base collar 30 is preferably a one piece injected-molded material, such as high density polyethylene (HDPE) or polypropylene (PPL), but any suitable material may be used.

To the extent described above, the cap 20 and base collar 30 are generally of known construction and form a non-pouring, push-pull type closure for squirting or dispensing liquid in bursts out of a standard beverage container 50. As will now be described, the closure has been modified to provide a unique vented closure which solves numerous problems with prior closures for non-pouring liquid containers. Furthermore, these modifications are adaptable to existing molding and assembly machinery so as to minimize the cost of providing a vented closure for a standard liquid container.

One or more small diameter vent apertures 70 are located in a middle region of the collar 30, such as in the second ring shelf 42 and extend through the shelf 42 as can be seen in FIGS. 1 and 3. Each vent aperture 70 is of a small cross-sectional area and location selected to perform self-sealing by surface tension of liquid in contact with the aperture 70. Each vent aperture 70 should be spaced sufficiently apart so as to operate independently of other vent apertures as to the self-sealing function. More than one vent aperture 70 is useful to increase venting air flow into the container, and three vent apertures are illustrated by way of example.

A divider baffle 72 extends through the hollow interior of the base collar 30, and is spaced from the side walls 32 and 40 by a sufficient distance to create a secondary liquid passageway 74 for conveying liquid from the container into direct contact with the vent apertures 70 when the container is tilted. The longitudinally extending divider 72 attaches at its upper end 76 to the third ring side wall 44, see FIG. 4. The divider lower end 78 is open and is generally flush with the bottom of the first side wall 32. The divider 72 has a generally W-shaped cross-section as seen best in FIG. 3. The legs of the W-shape are spaced away from the first side wall 32 sufficiently to allow the container neck 56 to be intermeshed therebetween, as seen in FIG. 4. The generally open liquid passageway 74 leads from the open bottom 78 upwardly without obstruction into direct contact with the vent apertures 70. It is important that no obstructions, seals, washers or the like block the fluid passageway 74 which must allow liquid to freely contact the vent apertures 70. The liquid passageway 74 is a secondary fluid passageway separate from the primary fluid passageway 46 which extends through the entire closure.

When cap 20 is closed and fully retracted down along the base collar 30, as seen in FIG. 4, each vent aperture 70 is sealed by several mating surfaces. The tapered annular shelf 42 abuts the cap, and the cap lower ridge 60 is in tight contact with the second side wall 40.

Cap 20 includes a lower skirt 80 beneath the lower ridge 60 which is spaced radially outward and forms an air passageway 82 underneath the skirt 80. This air passageway 82 is contiguous with a third air passageway 84 formed under the bottom edge of the skirt 80 and which bends upwardly inside the rim 35 and is open to external air.

As the cap 20 is pulled outward, the cap upper ridge 62 slides along the collar side wall 44, and the cap lower ridge 60 slides along the collar side wall 40, until reaching a fully open position as seen in FIG. 5. When fully open, the cap upper ridge 62 engages the collar rim stop 64 and prevents further movement of the cap.

Importantly, the cap lower ridge 60 is located to clear contact with the second side wall 40 and opens a narrow annular gap as seen in FIG. 5. As a result, external air can travel under the skirt 80 and via the air passageways 84 and 82 into an air chamber 86 formed between the cap skirt and the third side wall 44. This supplemental air chamber 86 is in direct contact with all air vents 70 to convey external air under the cap skirt and directly into contact with all air vents 70. However, air does not initially pass into the interior of the base collar, because each air vent 70 is effectively sealed by the surface tension of the liquid in contact with it, as illustrated in FIG. 5. Namely, the potential energy of the liquid volume below the dashed line Y-Y in FIG. 5 is insufficient to overcome the coefficient of surface tension which seals each vent opening 70. The relationship which creates the self-sealing action by surface tension will be further explained in connection with FIGS. 8a and 8b.

As a pressure differential is created by squeezing the container bottle, and/or by a user placing his or her mouth over the cap 20 and sucking to create a vacuum, liquid in the container will flow in a squirt or burst through the primary fluid passageway 46 along the direction of the arrow 68 in FIG. 6. At the same time, vent air will pass along the dotted lines 90 from outside the cap and under the skirt into air passageways 82 and 86 and then through the vent aperture 70 and into the secondary liquid passageway 74. The resulting air bubbles 92, which are not to scale, will travel through the liquid passageway 74 and into the container to vent the container to external air.

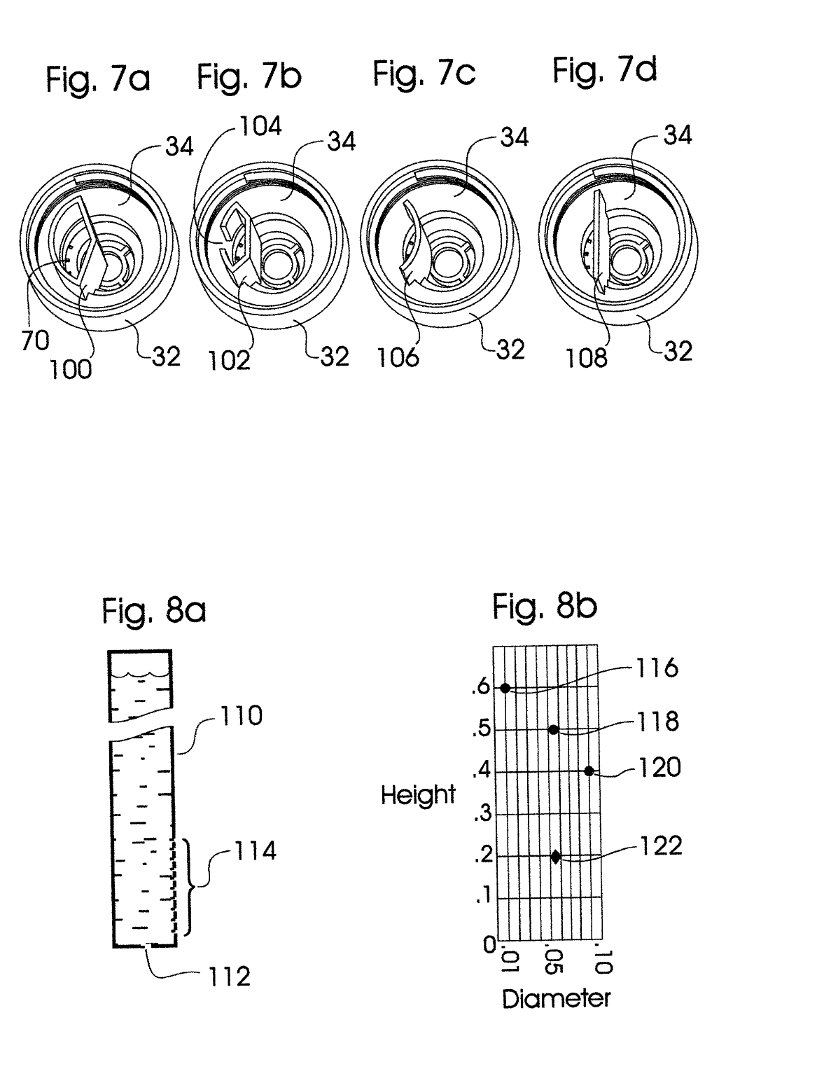

The divider 72 can take a variety of configurations such as seen in FIGS. 7a to 7d. For example, the divider can be in the form of an enclosed riser tube 100 as seen in FIG. 7a. The riser tube 100 consists of wide V-shaped walls near the center and an arcuate end which is parallel with the inside first side wall 32. One advantage of an enclosed riser tube is that venting air will not escape around the sides of the baffle into the primary liquid passageway 46, but the shape is more complex to form. Alternatively, the divider can be in the shape of a partially enclosed baffle 102, FIG. 7b, which has an open slot 104 partially or totally along a section furthest removed from the main fluid passageway. While venting air will escape through the open slot 104, the location of the slot is farthest away from the primary liquid flow path. Another form of divider is a curved wall 106 as seen in FIG. 7c. Alternatively, the baffle can be a flat wall 108 as seen in FIG. 7d. These dividers are generally less effective in separating venting air from the primary fluid path, but have other advantages in terms of ease of molding.

Each divider provides a direct liquid passageway for allowing liquid to freely contact all vent apertures 70, without vapor lock, allowing venting air to pass with minimal intermixing with the primary liquid passageway which could cause problems due to the entrapment of bubbles. Each divider is preferably asymmetrically formed to one side of the central interior space and in closer proximity to one side of the upright container neck, so as to guide the flow of venting air away from the main liquid flow which passes primarily through the open central region of the collar.

Each vent aperture 70 has an opening of a size and a location along the base collar 30 sufficient to substantially self-seal the vent aperture due to surface tension of the liquid in the container. As the distance between the cap top 22 and the location of the vent apertures 70 increase, the cross-sectional area of the vent openings must decrease in order to maintain self-sealing by surface tension of the liquid. The vent apertures 70 could be located on the first ring such as on the shelf 34, for example, but this requires a very small diameter vent aperture in order to maintain a self-sealing relationship. A very small diameter opening is more apt to be blocked by dust, dirt and other conditions. Conversely, the vent apertures 70 could be located on the upper third ring such as on the side wall 44. But it is more feasible for molding purposes to locate the vent aperture 70 on one of the generally horizontal ring shelves. A location on the second ring, and desirably on the shelf 42, provides a good balance between self-sealing properties and the size and location of the air vent.

FIG. 8a shows a test apparatus constructed to determine the relationship between the cross-sectional area of each vent aperture 70 and the distance away from the main fluid disbursing opening 24. A tubular container 110 of PVC plastic was constructed of approximately 10 inches height and 1 inch internal diameter, and was sealed at both ends. In the center of the bottom, a liquid dispensing bore 112 was drilled of ¼ inch diameter. A plurality of test vent apertures 114 were drilled into the plastic tube 110. The first vent aperture was located 0.1 inch from the inside bottom end of the container. A total of ten small diameter vent apertures 114 were drilled, each at 0.1 inch spacing. To provide sufficient distance between each test aperture, the ten vent apertures 114 were located along a spiral path around the external diameter of the tube so that each vent diameter could be drilled to a larger diameter.

Vent holes 114 initially were all of the same 0.01 inch diameter. All ten holes were covered with tape to form an airtight seal. The container 110 was filled with water. The apparatus was oriented with the dispensing opening 112 at the bottom as illustrated in FIG. 8a. No liquid was then being dispensed through the opening 112. Next, the tape was removed to expose the vents 114 one at a time from the bottom up. As the first five vents were exposed to air, no liquid escaped through the dispensing bore 112. When the sixth vent was uncovered at a vertical height of 0.6 inch, venting air began to flow into the interior of the sealed container 110 and water was dispensed through the dispensing bore 112.

FIG. 8b is a graph which plots the experimental results of the height and diameter of the vent apertures 114 relative to the point at which liquid was dispensed from the test apparatus of FIG. 8a. The vertical axis labeled Height represents the height in inches above the dispensing bore 112 at which the venting first became effective to cause liquid to be dispensed. The horizontal axis labeled Diameter represents the diameter in inches of all of the vent apertures 114. The first test point 116 indicates that liquid was first dispensed when the applicable vent aperture 114 had a diameter of 0.01 inch diameter and a height of 0.6 inch above the dispensing bore 112.

Next, all ten of the vent apertures 114 were drilled larger to a 0.055 inch diameter. Water again filled the container 110 and the vent apertures 114 were sealed with tape. Each vent aperture was opened from the bottom. Water first escaped through the dispensing bore 112 when the fifth aperture was uncovered. As indicated in the plot in FIG. 8b, a test point 118 illustrates venting for a diameter of 0.055 inch and a height of 0.5 inch.

Then, the vent apertures 114 were increased by drilling to a size of 0.09 inch diameter. When the test was repeated, water began to flow when the fourth hole was uncovered at a height of 0.4 inch. This is represented by a test point 120 in FIG. 8b of a height of 0.4 inches and a 0.09 inch diameter.

As demonstrated by the graph of FIG. 8b, as the distance from the dispensing opening increases, the cross-sectional area forming the vent aperture must decrease. In another test when the vent apertures 114 had diameters of 0.055 inch, a soap surfactant was added to the liquid water and the experiment was repeated. This surfactant caused a reduction in surface tension, and caused the liquid with surfactant to flow when the second hole was uncovered at a height of 0.2 inch, as indicated by an alternate test point 122 in FIG. 8b. Thus, the weight of liquid which could be supported was reduced by about 60% due to a reduction in surface tension.

As seen in FIG. 8b, the test results have a fairly linear curve as concerns the maximum weight of a particular liquid which can be supported by surface tension versus vent hole size. The configuration of the vent aperture and material also are factors to a lesser degree. Thus, placement and size of the vent apertures 70 in the base collar 30 can be empirically determined for the closure and liquid to be dispensed. As the vent apertures 70 are moved further away from the dispensing bore 24, the cross-sectional area of each vent aperture 70 must be decreased in order to perform a self-sealing relationship due to surface tension of the liquid.

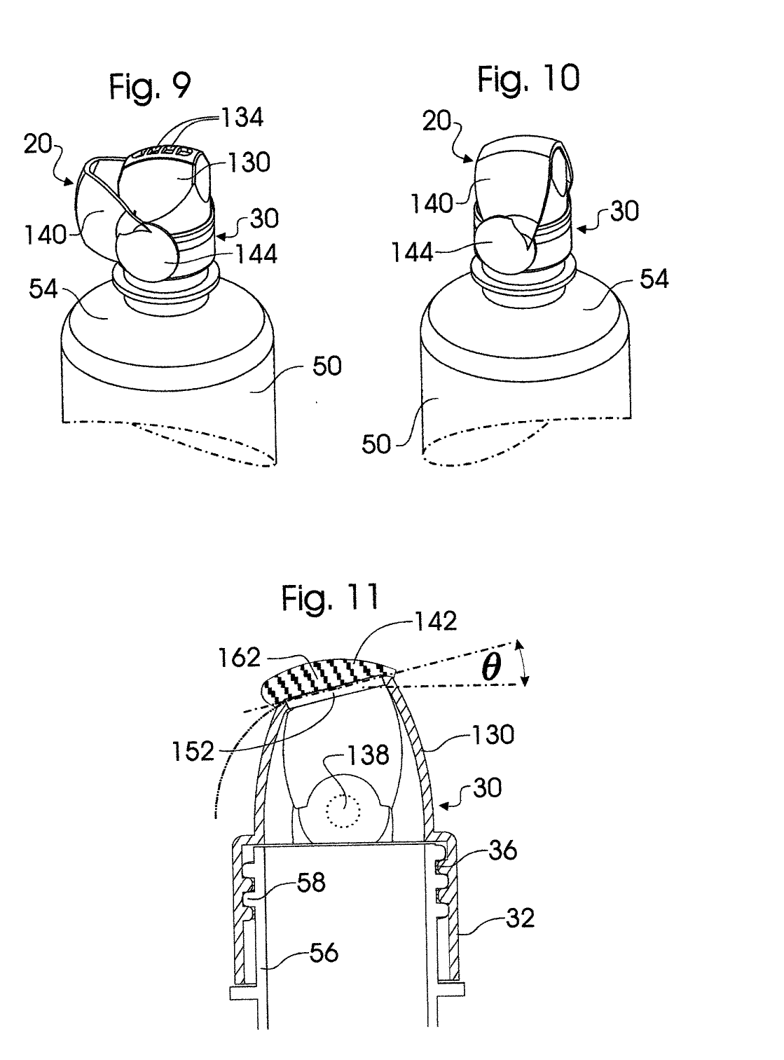

FIGS. 9 to 14 show additional embodiments for the cap 20 movably mounted relative to base collar 30 and having one or more vent apertures 70. These embodiments each utilize a rotating cap which can be flipped by one hand operation, as contrasted to a slidable push-pull cap as in the prior embodiment. Each base collar 30 includes a lower annular ring of large diameter having a side wall 32 with internal threads 36 for screwing attachment to the external threads 58 on the upright neck 56 of the fluid container 50. The side 32 extends inward and then upwardly to a raised central neck 130 having a generally tapered and rectangular shape. A series of top dispensing openings 134 each separated by a ridge as seen in FIG. 9 allow a larger total opening area without allowing the liquid to pour through the main dispensing outlet. Each opening 134 is spaced sufficiently apart by the ridge so as to operate separate and independently of the other multiple dispensing openings 134 to allow surface tension to form and create a non-pouring spout. The raised central neck 130 is shaped so that it can be formed by two halves of a mold without the necessity for retracting slides within the mold. Near the bottom of the central neck are a pair of pivot pins 138 extending outwardly from each side to form an axis for the rotatable cap 20.

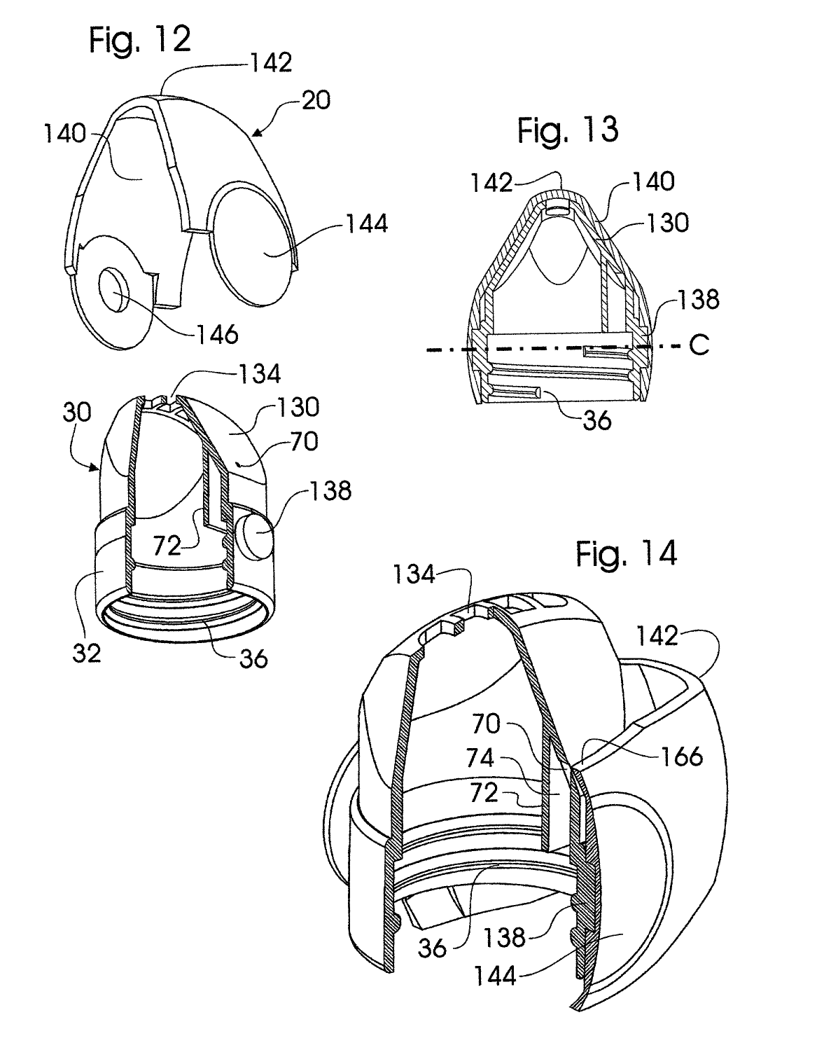

Cap 20 is formed of a generally U-shaped cover 140 having a central bight 142 and a pair of extending legs terminating in circular disks 144 each containing a circular bearing hole or recess 146, see FIG. 12, which snap fits over the pivot pins 138 of the collar. The cap cover 140 can rotate between an open position, seen in FIG. 9, and a closed position, seen in FIG. 10 to close the dispensing openings 134.

To improve sealing of the cap cover 140, a resilient compliant sealing material, such as food grade polyvinyl chloride (PVC), can be molded or inserted at an inner surface of the rotating cap. Such an insert 162 can be inserted into a region of the bight 142 or can form the bight 142. To further improve sealing of the main liquid passageway when in the closed position of FIG. 10, the top bight 142 of the U-shaped cover can have an angled shape for the respective mating surfaces of the rotating cap and the top surface of the central raised portion 130. As seen in FIG. 11, an inner surface 152 of the cap can form a ramp angle θ from a tangent of a swing arc, such as an angle between seven degrees and fifteen degrees. This ramped surface causes a positive seal stop as the cap is rotated to a closed position.

One or more vent apertures are located in the collar 30. In the illustrated embodiment, only a single vent aperture 70 is utilized and which has a small area of opening so that surface tension of the liquid will self-seal the vent until a pressure differential causes air to enter through the vent aperture 70. As seen best in FIGS. 12 and 14, the vent aperture 70 is formed vertically as a small diameter bore through the raised central neck 130. It directly communicates with the generally flat divider 72 which forms the secondary liquid passageway 74 to one side of the collar. The pivot disk 144 includes an overlapping skirt 166 which covers the vent opening 70.

The present invention has been described in an illustrative manner. It should be understood and evident that modifications may be made to the specific embodiments shown herein without departing the spirit and scope of the present invention. Such modifications are considered to be within the scope of the present invention.

What is claimed is:

1. A closure for a container for a liquid, comprising:
a base collar engagable with the container and having an outlet aperture for dispensing the liquid and spaced therefrom at least one vent aperture of a small size so that surface tension of the liquid can block the vent aperture, a primary liquid passageway extending through the base collar to the outlet aperture for dispensing liquid through the outlet aperture, and a secondary liquid passageway at least partly separate from the primary liquid passageway and extending through the base collar to the vent aperture for conveying the liquid from the container directly into contact with the vent aperture,
a cap movable on the base collar between at least open and closed positions, a stop surface associated with one of the base collar and the cap and relatively movable to open and obstruct at least the primary liquid passageway as the cap is moved respectively between the open and closed positions,
whereby the secondary liquid passageway permits air to enter the base collar to vent the closure for dispensing the liquid when the cap is in the open position and also seals the vent aperture by the surface tension of the liquid when dispensing of the liquid is to cease.

2. The closure of claim 1 wherein the base collar includes a divider extending into a hollow interior region of the collar to at least partially separate the primary liquid passageway from the secondary liquid passageway.

3. The closure of claim 2 wherein the divider comprises a baffle which partially surrounds the secondary liquid passageway and has a longitudinal opening extending opposite from the primary liquid passageway.

4. The closure of claim 1 wherein the base collar extends from a bottom region having threads for attachment to the container to a top region containing the outlet aperture, and the at least one vent aperture is located in an intermediate region between the outlet aperture and the bottom region.

5. The closure of claim 4 wherein the base collar includes a divider extending from the intermediate region to the bottom region to separate the primary liquid passageway from the secondary liquid passageway.

6. The closure of claim 1 wherein the base collar includes a first substantially annular ring attachable to the container and having a first annular shelf, a second substantially annular ring connected to said first annular shelf and having a diameter smaller than the first ring and a second annular shelf, a third substantially annular ring connected to said second annular shelf and having a diameter smaller than the second ring with a top of the third ring containing the outlet aperture, and said at least one vent aperture being located in one of said second substantially annular ring and second annular shelf.

7. The closure of claim 6 wherein the at least one vent aperture is located in the second annular shelf of the second ring.

8. The closure of claim 6 wherein the stop surface includes a stopper plug connected to said third substantially annular ring, the cap includes an exit aperture generally aligned with the outlet aperture when the cap is in the open position, and the stopper plug engaging the exit aperture when the cap is in the closed position.

9. The closure of claim 1 wherein the base collar includes a vent riser tube extending from the at least one vent aperture and into a hollow interior of the base collar to define the secondary liquid passageway.

10. The closure of claim 1 wherein the base collar includes at least one annular ring having a side wall extending generally longitudinally with respect to the primary liquid passageway, and the cap including an annular skirt slidably movable along the side wall of the annular ring to form a pull to open and push to close closure.

11. The closure of claim 1 wherein the base collar includes a pair of extending pivot pins, and the cap includes legs rotatably mounted to the pivot pins and rotatable between the open and closed positions to form a flip top closure.

12. The closure of claim 11 wherein the cap further includes a resilient insert for closing the primary liquid passageway of the base collar when said cap is in the closed position.

13. The closure of claim 11 wherein the base collar has a top surface containing the outlet aperture and which has a shape of rotation about a pivot axis for the pair of extending pivot pins, and the cap includes a lower surface which has a shape of rotation about the pivot axis.

14. The closure of claim 11 wherein the base collar has a top collar surface which is angled, and the cap has an interior stop surface which is angled similarly to the top collar surface and obstructs the primary liquid passageway when the cap is in the closed position.

15. A closure for a container for a liquid, comprising:
a base collar engagable with the container and having an outlet aperture for dispensing the liquid and spaced therefrom at least one vent aperture, a dispensing passageway extending through the base collar to the outlet aperture for dispensing the liquid through the outlet aperture, a vent passageway extending through the base collar to the vent aperture to permit air to enter the base collar,
a cap movable on the base collar between at least closed and open positions and having a skirt which extends over the base collar and overlaps the vent aperture as the cap is moved between the closed and open positions, an air passageway located between the skirt and the base collar and open at one portion to air and having another portion in direct contact with the vent aperture at least when the cap is in the open position, whereby the skirt of the cap overlaps and shields the vent aperture on the base collar.

16. The closure of claim 15 wherein the base collar includes a divider extending into a hollow interior region of the collar with one side of the divider forming the dispensing passageway and an opposite side of the divider forming a secondary liquid passageway extending into direct contact with the vent aperture for conveying a liquid from the container directly into contact with the vent aperture.

17. The closure of claim 16 wherein the at least one vent aperture is of a size and location on the base collar so that surface tension of the liquid will block the vent aperture when the cap is in the open position until a pressure difference causes dispensing of the liquid through the primary liquid passageway and venting air to enter the secondary liquid passageway.

18. The closure of claim 15 wherein the base collar includes at least one annular ring having a side wall extending generally longitudinally with respect to a primary liquid passageway extending through a hollow interior to the outlet aperture, and the skirt of the cap being slidably movable along the side wall of the annular ring to form a pull to open and push to close closure.

19. The closure of claim 15 wherein the base collar includes a pair of extending pivot pins, and the skirt of the cap is rotatably mounted to the pivot pins and is rotatable between the open and closed positions to form a flip top closure.

20. The closure of claim 15 wherein the skirt of the cap includes recessed portions under the skirt and forming an air passageway contiguous with the at least one vent aperture when the cap is in the open position.
